(19) United States
(12) Patent Application Publication
(10) Pub. No.: US 2006/0255970 A1
(43) Pub. Date: Nov. 16, 2006

(54) Map location system

(75) Inventors: Chao-Yen Lin, Luzhou City (TW); Li-Ly Chiu, Banqiao City (TW)

Correspondence Address: TROXELL LAW OFFICE PLLC, SUITE 1404, 5205 LEESBURG PIKE, FALLS CHURCH, VA, 22041, US

(73) Assignee: Chao-Yen LIN

(21) Appl. No.: 11/128,270

(22) Filed: May 13, 2005

(51) Int. Cl. G08G 1/123

(52) U.S. Cl. 340/995.1

(57) ABSTRACT

The present invention finds a required geographic location on a map having a plurality of map units; the distance and locality between two locations are figured out; and, map units are pierced up.

### FIELD OF THE INVENTION

The present invention relates to a location system; more particularly, relates to utilizing a specific landmark (such as the Empire State Building) as an apparent marker for easily referencing a map, figuring out the direction and distance between two locations, and piercing up maps.

### DESCRIPTION OF THE RELATED ART

A map (such as a map of the U.S.A.) according to a prior art is a geographic map with longitude and latitude markers at the border, with names of locations, railways, highways, etc., with natural spots in the map, and with a scale. A geographic location can be located by the longitude and latitude markers.

Although a geographic location can be located by the longitude and latitude markers on the map of the prior art, the map is usually full of markers and numbers making it look complex. Such a map is not easy to use for a general user, except an expert. Besides, if a user wants to figure out the distance between the present location and a destination, it is usually not possible. So, the prior art do not fulfill users' requests on actual use.

### SUMMARY OF THE INVENTION

Therefore, the main purpose of the present invention is to utilize a specific landmark as an apparent marker for easily understanding and using a map to locate a required geographic location.

Another purpose of the present invention is to figure out the direction and distance between two locations on the map.

Still another purpose of the present invention is to pierce up maps.

To achieve the above purposes, the present invention is a map location system, including a map of the U.S.A., which is comprised with a plurality of map units having at least one hole at a side; a coordinate system with an X-axis directing eastward and westward and a Y-axis directing northward and southward; an origin for the coordinate system of the map, obtained on a top of a specific landmark (such as the Empire State Building); a number area deposed at the outside border of the map or on the X-axis and Y-axis. Accordingly, by using the specific landmark as an apparent marker, a required geographic location is found easily on the map; distance and locality between two locations are easily figured out; and, the map units are pierced up.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a perspective view showing a first preferred embodiment according to the present invention;

FIG. 2 is an explosive view showing a second preferred embodiment according to the present invention;

FIG. 3 is a view showing a status of use according to the present invention; and

FIG. 4 is a view showing another status of use according to the present invention.

### DESCRIPTION OF THE PREFERRED EMBODIMENTS

The following descriptions of the preferred embodiments are provided to understand the features and the structures of the present invention.

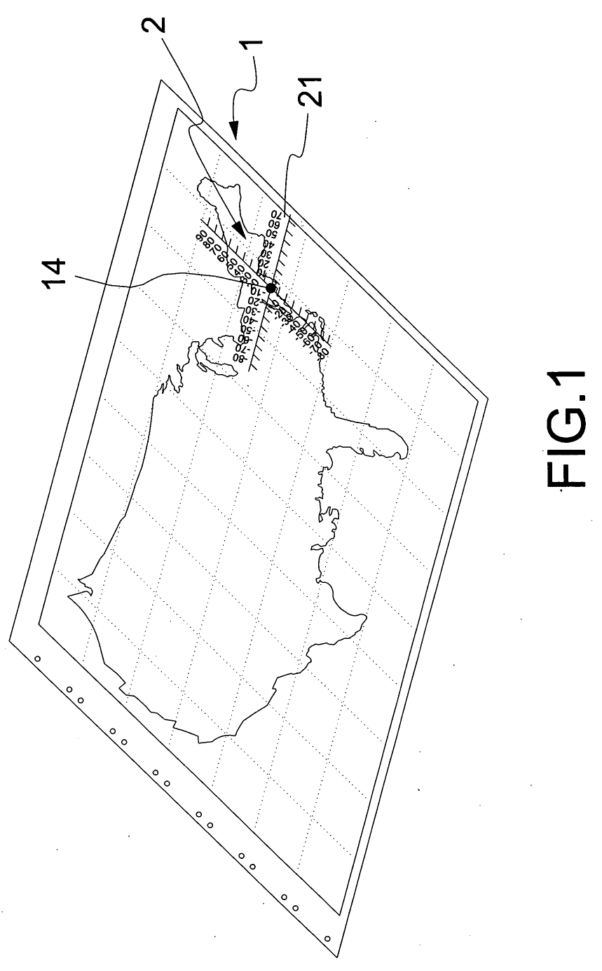

Please refer to FIG. 1, which is a perspective view according to a preferred embodiment of the present invention. As shown in the figure, the present invention is a map location system, comprising a map 1 of the U.S.A., an origin 14, a coordinate system 21 and a number area 2. Therein, the origin 14 is obtained on a top of a specific landmark 14 (such as the Empire State Building); the coordinate system located on the map 1 is comprised with the origin 14, an X-axis having a positive direction eastward and a negative direction westward, and a Y-axis having a positive direction northward and a negative direction southward; and, the number area 2 is deposed on the X-axis and Y-axis with numbers labeled in a scale of kilometer according to the coordinate system 21. Hence, with the help of the specific landmark 14 as an apparent marker, a required geographic location is found easily on the map, and distance and locality between two locations are easily figured out.

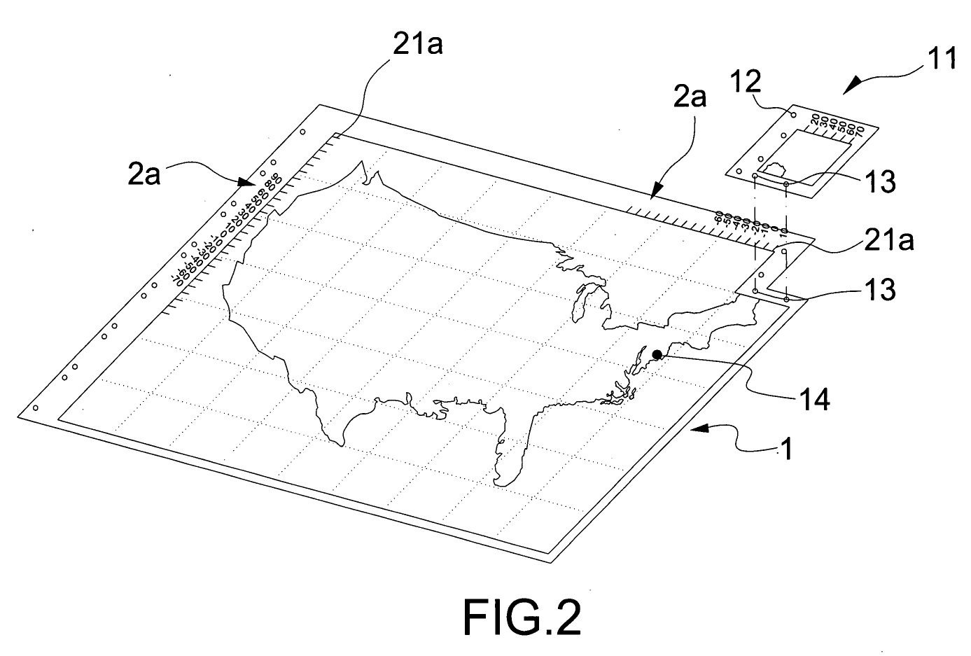

Please refer to FIG. 2, which is an explosive view according to an other preferred embodiment of the present invention. As shown in the figure, the present invention is a map location system, comprising a map 1 of the U.S.A., an origin 14, a coordinate system 21a and a number area 2a. Therein, the map 1 of the U.S.A. is comprised with a plurality of map units 11; the map unit 11 is comprised with at least one hole 12 at a side, and is connected with another map unit 11 at a connection part 13 to be fixed with each other by protrusions and cavities, by a magnet, or by a clip; the origin 14 is obtained on a top of a specific landmark (such as the Empire State Building); the coordinate system 21a is deposed on the map 1 and is comprised with the origin 14, an X-axis directing eastward and westward, and a Y-axis directing northward and southward; and, the number area 2a is deposed at the outside border of the map 1 with numbers labeled in a scale of one kilometer according to the coordinate system 21a.

Besides, by the numbers labeled on the number area 2a, map units 11 are pierced up. When piercing up map units 11, they are fixed with each other at the connection part 13 to obtain a function of piercing-up. Nevertheless, the map unit 11 is carried along, or map units 11 are made into a volume by using the hole 12 at a side, so that the map unit 11 is carried out easily for use as required. Consequently, a novel map location system is obtained by the above structure.

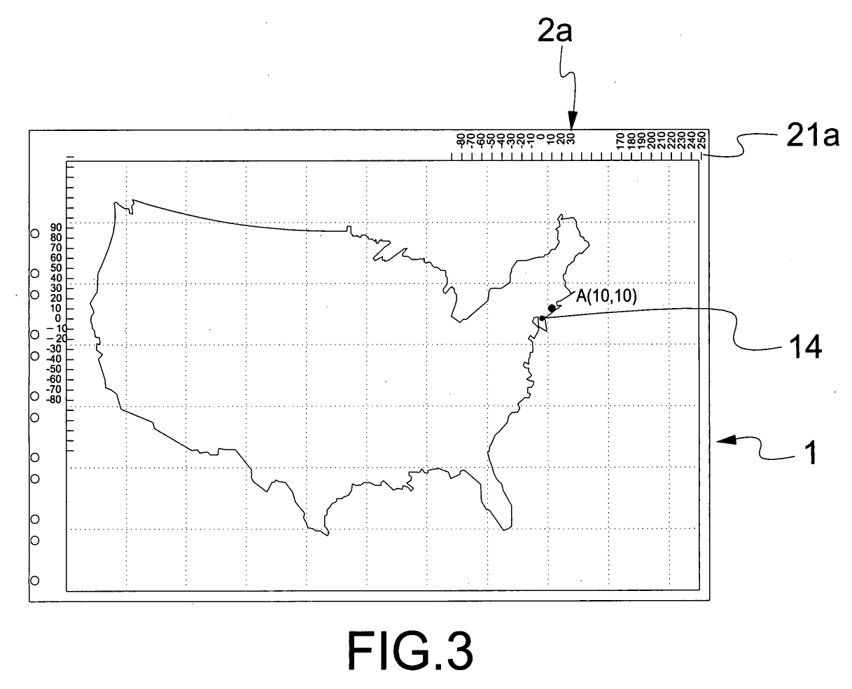

Please refer to FIG. 3, which is a view showing a status of use according to the present invention. As shown in the figure, by using a top of a specific landmark as an apparent marker to be an origin 14 of a coordinate system 21a in a map 1, the map 1 is used and understood with ease. Furthermore, when a target of a highway, a building or a facility is labeled with numbers on the map 1 or with numbers stored in a media as referring to the coordinate system 21a the target is located more easily. For example, when a user is located at a position ‘A’ which is labeled as A(10, 10) by referring to the coordinate system 21a in a number area 2a, the position ‘A’ is located by 10 kilometers northern together with 10 kilometers eastern, or 14.1 kilometers north-eastern, to the origin 14. As a result, when the user knows where he is (the position ‘A’) and he sees the specific landmark (the origin 14), the user distinguishes directions of the eastern, the western, the southern and the northern, done by stretching out his arms and turning his body to line up the body (position ‘A’) and the origin 14 (the specific landmark) while the arm is pointing to the specific landmark. If the position ‘A’ is far too much from the origin 14, the directions distinguished have to be amended by the magnetic declination.

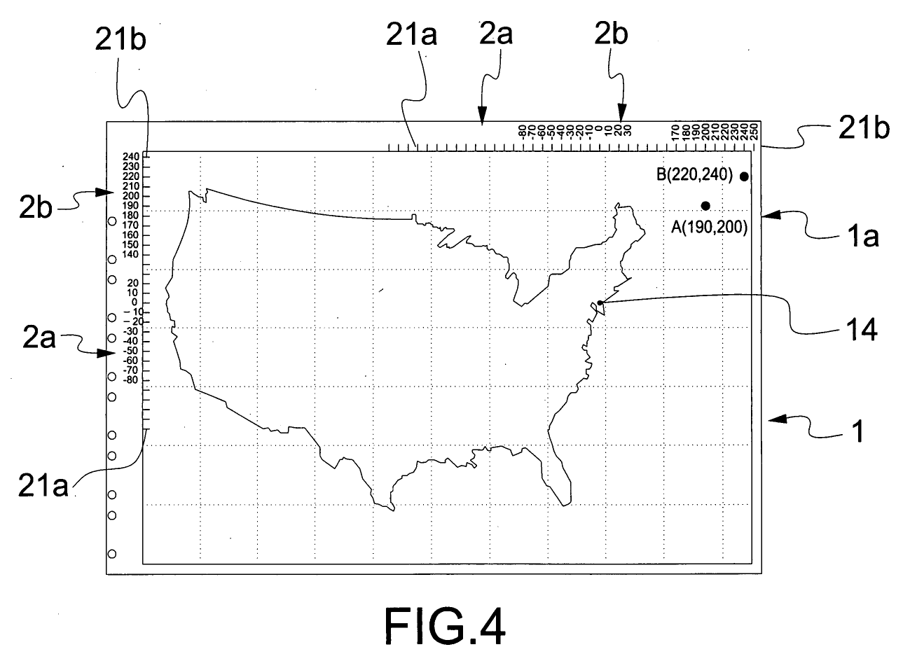

Please refer to FIG. 4, which is a view showing another status of use according to the present invention. As shown in the figure, even though there is another map 1a using another coordinate system 21b different from the coordinate system 21a in a number area 2a of the original map 1, the same position for the origin 14 of the original map 1 is easily found on the another map 1a as referring to the coordinate system of the another map 1a, so that the two maps are overlapped with each other and are connected into an integrated map for easy reference. At the same time, using the coordinate system 21b of the another map 1a, the direction and the distance between any two locations on the another map 1a are figured out. For example, the distance between two locations of A(190, 200) and B(220, 240) labeled by referring to the coordinate system 21b of the another map 1a is figured out by the following steps: (1) to square the result of subtracting the X-axis number of position ‘A’ to that of position ‘B’; (2) to square the result of subtracting the Y-axis number of position ‘A’ to that of position ‘B’; (3) to sum up the result of step (1) and that of step (2); and, (4) to get the square root of the result of step (3). In the end, a straight distance of 50 kilometers is obtained according to the example.

Beyond question, the present invention is used in an electric map. Numbers for two location labels found on a paper map according to the present invention are easily inputted into the electric map so that a route between the two locations is shown immediately. In addition, the present invention is used with a mobile or a PDA (Personal Digital Assistant) having a function of a compass. When using, numbers for the location labels locating the user and the destination are inputted in, the northern direction (N) and the distance between them are displayed.

When the numbers on the location labels are displayed through GPS (Global Positioning System) to locate present location by referring to a map of the present invention, facilities around present location are displayed on a web site or a PDA, or in a call service center.

Because location labels are easily found in a paper map according to the present invention, anyone shares beauty spots around through the Internet without the help of any electric map or GPS.

Likewise, by inputting the location label of a destination into a handheld machine having GPS, such as a store, a beauty spot or a building provided by a newspaper, a magazine, a photograph (with a location label at the corner), or a website, a guidance to the destination is obtained.

To sum up, the present invention is a map location system, which, by using a specific landmark as an apparent marker, a required geographic location is found easily on a map having a plurality of map units; distance and locality between two locations are easily figured out; and, map units are pierced up.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A map location system, comprising:
a map;
an origin;
a coordinate system; and
a number area,
wherein said origin is obtained on a top of a specific landmark;
wherein said coordinate system is located on said map and is comprised with said origin, an X-axis having a positive direction eastward and a negative direction westward, and a Y-axis having a positive direction northward and a negative direction southward; and
wherein said number area is located on said X-axis and said Y-axis.

2. The map location system according to claim 1, wherein said map is comprised with a plurality of map units.

3. The map location system according to claim 2, wherein said map unit is comprised with at least one hole at a side of said map unit.

4. The map location system according to claim 2, wherein said map unit is connected with an other said map unit at a connection part.

5. The map location system according to claim 1, wherein said map is a map of the U.S.A. and said specific landmark is the Empire State Building.

6. The map location system according to claim 1, wherein numbers are labeled on said number area in a scale of kilometer according to said coordinate system.

7. A map location system, comprising:
a map;
an origin;
a coordinate system; and
a number area,
wherein said origin is obtained on a top of a specific landmark;
wherein said coordinate system is located on said map and is comprised with said origin, an X-axis having a positive direction eastward and a negative direction westward, and a Y-axis having a positive direction northward and a negative direction southward;
wherein said number area is located on an outside border of said map.

8. The map location system according to claim 7, wherein said map is comprised with a plurality of map units.

9. The map location system according to claim 8, wherein said map unit is comprised with at least one hole at a side of said map unit.

10. The map location system according to claim 8, wherein said map unit is connected with an other said map unit at a connection part.

11. The map location system according to claim 7, wherein said map is a map of the U.S.A. and said specific landmark is the Empire State Building.

12. The map location system according to claim 7, wherein numbers are labeled on said number area in a scale of kilometer according to said coordinate system.

13. A map location system, comprising:
a map;
an origin;
a coordinate system; and
a plurality of location labels,
wherein said origin is obtained on a top of a specific landmark;
wherein said coordinate system is located on said map and is comprised with said origin, an X-axis having a positive direction eastward and a negative direction westward, and a Y-axis having a positive direction northward and a negative direction southward; and
wherein said location label is located beside a target to locate said target on said map by referring to said coordinate system
wherein said target is selected from a group consisting of a highway, a building and a facility.

14. The map location system according to claim 13, wherein said map is a map of the U.S.A. and said specific land mark is the Empire State Building.

15. The map location system according to claim 13, wherein said location label is labeled beside the name of said target.

16. The map location system according to, claim 13, wherein location labels are stored in an electric media.

17. The map location system according to claim 13, wherein said target is selected from a group consisting of a highway, a building, and a facility.
